(19) United States
(12) Patent Application Publication
(10) Pub. No.: US 2014/0282033 A1
(43) Pub. Date: Sep. 18, 2014

(54) APPLICATION VERSION VERIFICATION SYSTEMS AND METHODS

(71) Applicant: MATTEL, INC., El Segundo, CA (US)

(72) Inventor: Bruce Cannon, El Segundo, CA (US)

(73) Assignee: Mattel, Inc., El Segundo, CA (US)

(21) Appl. No.: 13/841,757

(22) Filed: Mar. 15, 2013

(51) Int. Cl. G06F 3/0484

(52) U.S. Cl. CPC G06F 3/0484
USPC 715/738

(57) ABSTRACT

Embodiments include a system or method with an electronic device that includes a touch sensitive display screen that is configured to receive identification input from a contact device. The electronic device includes a processor configured to display a message to download one or more applications that are compatible with the contact device after the processor determines that the one or more applications are absent from the electronic device, and the processor is configured to change a display output based on the interactions with the contact device when the one or more applications that are compatible with the contact device are present in the electronic device.

### FIELD

Embodiments relate to electronic devices that include a touchscreen. Embodiments relate to systems and methods for determining the identity of an object using the touchscreen. The systems and methods search for and acquire applications that are compatible with various objects that contact the touchscreen. Embodiments relate to downloading applications that change a display on the touchscreen based on the movement of an object that is in contact with the touchscreen.

### BACKGROUND

Electronic devices that include a touchscreen are prevalent, and people enjoy interacting with a touchscreen. A touchscreen detects an object or a finger of a user and can detect multiple different touches that occur simultaneously. The amount of data that can be transferred through a touchscreen interface is limited.

Conventional peripheral devices make an electrical connection with an electronic device using a wire. After determining the identity of the peripheral device, the electronic device may download appropriate software (e.g. a device driver) to allow the peripheral device to interact with the electronic device.

### SUMMARY

One embodiment relates to an electronic device that includes a touch sensitive display screen capable of receiving contact information from a contact device. The electronic device includes a processor configured to identify the contact device based on an identifying pattern the contact device creates when the contact device is in contact with the touch sensitive display screen. The processor configured to determine whether one or more applications that are compatible with the contact device is absent from the electronic device and the processor configured to generate a message to download or access the one or more applications that are compatible with the contact device.

A system that includes an electronic device that includes a touch sensitive display screen that is configured to receive identification input from a contact device. The electronic device includes a processor configured to display a message to download one or more applications that are compatible with the contact device after the processor determines that the one or more applications are absent from the electronic device, and the processor is configured to change a display output based on the interactions with the contact device when the one or more applications that are compatible with the contact device are present in the electronic device.

A method that includes receiving an identification input through a touch sensitive display device on an electronic device. The method further includes determining one or more applications associated with the identification input and directing a user to the application when one of the one or more applications is available on the electronic device and is compatible with the contact device associated with the identification input. The method further includes directing the user to an application download message for downloading the one or more applications, when the one or more applications is absent from the electronic device or when the one or more applications that is on the electronic device is incompatible with a contact device associated with the identification input.

### BRIEF DESCRIPTION OF THE DRAWINGS

FIG. 1 is a schematic diagram of a computer-implemented data processing system according to an example embodiment.

FIG. 2A is a process implemented by the data processing system of FIG. 1 to download and execute an application that is compatible with a contact device.

FIG. 2B is another process implemented by the data processing system of FIG. 1 to download an application that is compatible with a contact device.

FIG. 2C is another process implemented by the data processing system of FIG. 1 to download an application that is compatible with a contact device.

FIG. 3 is an example device compatibility table that is used for determining the identity of a compatible application by the data processing system of FIG. 1.

FIG. 4A is a screen shot of an area on electronic device for identifying a contact device.

FIG. 4B is an illustration of a contact device that is placed on the electronic device from FIG. 4A.

FIG. 4C is an illustration of a screen from an application that is compatible with the contact device from FIG. 4B.

FIG. 4D is an illustration of a screen for downloading a compatible application when the compatible application is not located on the electronic device.

FIG. 4E is a screen shot of an application store screen that allows a user to download an application.

### DETAILED DESCRIPTION

Various implementations described below relate to an electronic device, such as a tablet computer, where the device utilizes a touchscreen interface to recognize a contact device (e.g. toy) that is placed into contact with the touchscreen. After recognizing the identity of the contact device, the electronic device may direct a user to a compatible application for using the contact device with the electronic device.

A smart device with a touchscreen, such as but not limited to, a tablet, laptop, computer, or mobile phone may be configured to determine the identity of a contact device that may be placed on the touchscreen. The contact device may be a toy, action figure, model, or the like. A software application that is on the smart device may be configured to identify whether or not the user has installed a compatible and valid application that allows a user to interact with a chosen contact device or contact device type. The user may choose to navigate to a compatible application or the user may be able to navigate to an application store to download a compatible application.

In some implementations, a portal may guide the user to place their contact device (e.g. toy, figurine, etc.) on a portion of a starting page of an application. The portal scans a contact pattern created by the contact device to determine the identity of the contact device. In the case where the contact device is unidentifiable, the portal may instruct the user to rotate the contact device or to select the appropriate contact device from a list or images of a plurality of compatible contact devices. In various embodiments, a contact device 150 may be compatible with or capable of interacting with one or more applications. In other embodiments, multiple contact devices may share a single touch pattern. When contact device 150 generates a single identifiable contact pattern that is capable of initiating multiple applications, electronic device 110 may generate a menu requesting a user to select from a list of applications. In some embodiment, the menu may include an image of the contact device for each application, thereby allowing the user to choose an application with a contact device image that matches the contact device that the user possesses.

FIG. 1 is a schematic diagram of a computer-implemented data processing system 100 according to an example embodiment. The data processing system 100 allows one or more users to utilize one or more contact devices to interact with an electronic device 110. The one or more users may be, for example, a minor or an adult that has acquired a contact device 150 or a contact device 160. A single user, in one embodiment, may operate each contact device. In other implementations, a single user may operate more than one contact device, or different users may each operate one or more contact devices. The data processing system 100 may be used to upload, download, acquire, or access one or more compatible applications into the electronic device 110. The one or more compatible applications are applications that are capable of interacting with the one or more contact devices. Additionally, a software provider that is different from the manufacturer of the one or more contact devices may provide the one or more compatible applications. Alternatively, the one or more compatible applications may be created by the manufacturer of the contact devices and provided to a software distribution company that allows a user to upload, download, acquire, or access the one or more compatible applications.

Data processing system 100 may include, among other systems, the electronic device 110, a network 130, the contact device 150, the contact device 160, an application provider 180, and an application provider 190. The electronic device 110, the contact device 150, the contact device 160, the application provider 180, and the application provider 190, may communicate through the network 130. The network 130 may include one or more of the Internet, a cellular network, a Wi-Fi network, a Wi-Max network, a proprietary software distribution network, a gaming network, and so on. The electronic device 110, the application provider 180, and the application provider 190 may each comprise a computer system (e.g., one or more servers each with one or more processors) configured to execute instructions, send and receive data stored in a non-transitory memory, and perform other operations to implement the operations described below in the processes shown in FIGS. 2A through 2C.

The electronic device 110 may be used by an individual user (e.g., a child, an adult, a consumer, and so on) to allow the contact device 150 that is separate from the electronic device 110 to interact with the electronic device 110 via a touchscreen interface of the electronic device 110. The electronic device 110 may, for example, be a cellular phone, smart phone, mobile handheld wireless e-mail device, personal digital assistant, portable gaming device, tablet, laptop, camera, monitor, desktop computer, or other suitable device. The electronic device 110 comprises a display device 111, a processor 113, a network interface circuit 115, a contact device identifier circuit 117, an application searcher 119, and a storage system 120. Each of the above components are described in greater detail below. In some embodiments, the electronic device 110 may also include an image capture device to capture the image of a contact device. The electronic device 110 may include an input device that can be a touch device integrated into the display device 111, a keyboard or special touch keyboard that is connected to or generated by the electronic device 110, or an application on the electronic device 110.

The electronic device 110 can be configured to access resources provided by an application provider using an application or a web browser with a connection to the network 130 (e.g. the Internet). The application providers 180 and 190 may publish applications to the electronic device 110 using various digital online marketplaces. The name or web address of the marketplace may depend on the operating system of the electronic device 110. Users may, for example, use the electronic device 110 to perform various tasks such as playing a game or interacting with the electronic device 110 using one or more contact devices. Examples of operating systems include iOS®, Windows Phone®, Windows®, Symbian®, Android®, Blackberry®, WebOs®, and so on. The electronic device 110 may be configured to operate using one or more of the above mentioned operating systems.

The electronic device 110 may allow a user to place the contact devices 150 and/or 160 on the display device 111, and the processor 113 may determine the identity of each contact device that is on the display device 111. The electronic device 110 may determine whether one or more applications that are compatible with the contact device are available, accessible and/or located on the electronic device 110. The electronic device 110 may search the storage system 120. Although in the illustrated embodiment the electronic device 110 is used to determine the identity of the contact device, it will be appreciated that the electronic device 110 may identify the contact device using different mechanisms, for example, through an online device identification area of a website of the contact device provider that allows a user to upload an image of the contact device or an image of an imprint made by the contact device.

The display device 111 may be a touch sensitive display device capable of sensing multiple contacts from one or more contact devices. The touch sensitive device may use resistive, surface acoustic wave, infrared sensing, optical imaging, capacitive sensing, acoustic pulse recognition and/or other suitable technologies to determine the points of contact and the pattern created by the contact device. The display device 111 may receive the touch based identification input from a contact device that contacts the display device 111. The identification input represents the points at which a contact device changes an electrical, resistive, or capacitive pattern, and the distances between the contact points may be used by the processor 113 to determine the identity of the contact device. Systems and methods of identifying a contact device are described in greater detail in U.S. Patent App. Pub. No. 2011/0227871 (owned by the applicant of record for the present application), which is incorporated by reference herein in its entirety. In particular, FIGS. 34-46 from U.S. Patent App. Pub. No. 2011/0227871 illustrates an example method or system of identifying a contact object. Moreover, the description of FIGS. 34-46 from U.S. Patent App. Pub. No. 2011/0227871 further explains the distance measurement techniques between various contact members that may be used.

The display device 111 may be configured to generate images and a user interface for the user of the electronic device 110. For example, the display device 111 may prompt the user to enter authentication information for the application provider or for store access. The display device 111 provides visual feedback to the user when the user moves the contact device 150 or 160. In one example, the display device 111 may display guides under the contact device that is in contact with the display device 111. The guides may include a request to the user to place the contact device 150 or 160 within a desired area of the screen to permit scanning of the contact device 150 or 160.

The processor 113 receives and transmits commands and data from other devices and circuits from within the electronic device 110. The processor 113 may communicate with each of the various devices and circuits in the electronic device 110. In some embodiments, the processor 113 may be configured by software within the storage system 120 to perform certain actions, such as but not limited to, generating displays to the user when an application that is unavailable on the electronic device 110 needs to be downloaded.

Network interface circuit 115 may include, for example, program logic that connects the electronic device 110 to the network 130. As described in greater detail below, for example, the electronic device 110 may receive and display screens, and so on. In an example embodiment, such screens may be used to request authentication information (e.g. username and password). Such screens may also be used to prompt the user to grant permission to download or upload a compatible application from an application provider. Such screens are presented to the user via the display device 111. The electronic device 110 may connect (wirelessly or via a wire) to an input device that may be used to permit the user to provide authentication information for the application providers. As will be appreciated, in addition to or instead of the electronic device 110, users may also be provided with the ability to access the applications using another type of computer (e.g., a desktop or laptop computer executing browser software) to perform the operations described in this disclosure as being performed by the electronic device 110.

The contact device identifier circuit 117 may be integrated with the processor 113 and the storage system 120. The contact device identifier circuit 117 may receive the contact information from the display device 111 and be configured to determine the distances between various contact members of the contact device. The distances and the contact pattern created by the contact devices may be unique for each contact device, each type of contact device, or for each type of contact device intended for a particular application. As mentioned above, the description of FIGS. 34-46 in U.S. Patent App. Pub. No. 2011/0227871 explains various methods of identifying a device and is incorporated by reference herein in its entirety. The contact device identifier circuit 117 may be configured with the methods or systems from the above-mentioned patent application publication. In various embodiments, the contact device identifier circuit 117 may be implemented in the processor 113. In some embodiments, the contact device identifier circuit 117 may query a database in the storage system 120 with the measurement values of the sensed pattern to determine which device is being placed on the display device 111. In some embodiments, the storage system 120 may inform the contact device identifier circuit 117 regarding the identity of the contact device. The contact device identifier circuit 117 may communicate the identity of the one or more contact devices to the processor 113. Next, the processor 113 may call the application searcher 119 to determine a compatible application for the contact device based on the determined identity of the contact device. In another embodiment, the contact device identifier circuit 117 may be initiated by an application that acts as a hub used to identify the contact device.

The application searcher 119 may query the storage system 120 for the application that is compatible with the contact devices 150 and/or 160. The query request may include the identity of the contact device by a determined name, number, and/or device identifier. The storage system 120 includes various systems such as an application data 122 and user data 124. The application data 122 may provide the application searcher 119 with the results regarding which application is compatible with the contact device 150 and/or contact device 160. For example, the application data 122 may include an application compatibility table as shown in FIG. 3. In other embodiments, the application searcher 119 may also ascertain from the storage system 120 whether the compatible application is located, stored, or accessible on the electronic device 110. The application data 122 may also respond to that request. The results generated by the application searcher 119 may be provided to the processor 113 to determine the next course of action. In the case where the compatible application is located on the electronic device 110, the processor 113 may prompt the user to initiate the compatible application. In the case where the compatible application is not located on the electronic device 110, the application data 122 may inform the processor 113 of the identity of the compatible application and an application store link or webpage to acquire the compatible application. In various embodiments, the application data 122 may include a local database that may include, among other structures, the application compatibility table 300, discussed in greater detail below. In the embodiment with a local database, the application searcher 119 may at least initially search the local database. After a determination that the local database lacks or fails to provide a compatible application, the application searcher 119 or the application data 122 may access a remote database (e.g. application provider 180 or 190) to update the local database with pattern recognition information for the new device. In other embodiments, the provider of the contact device scanning application may provide the remote database that updates the local database at application data 122.

As mentioned above, the network 130 may be a public network, such as the Internet, or a private network that is accessible by the electronic device 110. The network 130 allows the electronic device 110 to access various other networks, application provider 180, and/or application provider 190. The electronic device 110 accesses the network 130 through a variety of connection technologies. For example the electronic device 110 may use at least one of the following technologies: WIFI®, cellular (4G, 3G, 2G, and/or LTE), wired, Bluetooth®, Ethernet and so on. The network 130 may allow the electronic device 110 to download an application that is compatible with the contact device 150 or contact device 160 that are in contact with the display device 111.

The contact device 150 may be an object that includes one or more contact members. In some embodiments, the contact members may be made of conductive materials. In other embodiments, the contact members may be made on non-conductive materials. A user at a retail location may acquire the contact device 150. In some embodiments, the user may purchase the contact device 150 at a different retail location than the retail location of the electronic device 110. In other embodiments, different companies may manufacture the contact device 150 and the electronic device 110. The contact device 150 may be small enough in size relative to the display device 111 to move side to side, up and down, and rotate on the display device 111 without damaging the display device 111. The contact members may be electrically conductive or resistive and be sufficiently soft to not damage the display device 111. In another embodiment, the display device 111 may be covered with a protective sheath to prevent scratching by the contact device 150.

The contact device 150 include contact member 152, contact member 154, and contact member 156. The contact members 152, 154, and 156 may be spaced apart from each other such that when the contact device 150 is placed on the display device 111, the contact device identifier circuit 117 may be able to determine a unique pattern that is created on the touchscreen interface of the display device 111. The distance between contact member 152 and contact member 154 may represent a category of the contact device 150. The distance between the midpoint of the distance between the contact members 152 and 154 and the contact member 156 may allow the processor 113 of electronic device 110 to identify the contact device 150. Contact members 152, 154, and 156 create an imprint on the display device 111 that allows the electronic device 110 to ascertain the identity of the contact device 150.

In some embodiments, the contact device 150 may be an action figure or a toy for a child. The contact device 150 may include a non-conductive or conductive mold that may be held by a user when playing with the contact device 150 and the electronic device 110. In some embodiments, the electronic device 110 may generate a display to guide the user to place the contact device 150 in a designated scanning area of the display device 111 to determine the identity of the contact device 150. After the user places the contact device 150, the user may be prompted to rotate or move the contact device 150 to aid in the contact device identification process. In some embodiments, after downloading a compatible application, the electronic device 110 may begin the execution of the application. The contact device 150 may be moved by the user on the display device 111 and, due to the movement, the display that is generated may be changed. For example, a user may interact with a video game on the display device 111 using the contact device 150. The movements of the contact device 150 may change screen output on the display device 111.

Contact device 160 may be similar to contact device 150. Contact device 160 may include 2, 3, 4, 5, or any other suitable number of contact members. In the example embodiment of FIG. 1, the contact device 160 includes three contact members 162, 164 and 166 that may be similar to the contact members 152, 154, and 156 of the contact device 150. In some embodiments, the contact device 160 may interact with the display device 111 at the same time as the contact device 150 interacts with the display device 111. For example, a first user may use the contact device 150, and a second user may use the contact device 160. In an example embodiment, the first user may act as a first player and the second user may act a second player in the compatible application that receives input from the two contact devices. In other embodiments, the electronic device 110 may be able to divide the display device 111 into multiple screens for a multi-player experience. In other embodiments, the display device 111 may display a single screen that allows both users to interact with the electronic device 110 simultaneously in a cooperation mode of a video game.

In other embodiments, the contact device 160 may include a power source, processor, memory and/or a wireless communication capability. In an example embodiment, the contact device 160 may transmit information via a wireless link (e.g. Bluetooth) to the electronic device 110. The information that is transmitted may include the identity of the contact device 160, a compatible application, rank, points, or capabilities that the user of the contact device 160 has achieved. In another embodiment, the contact device 160 may include a user selectable button that may project a new contact member that contacts the display device 111. The user selectable new contact member may allow the user to create a pattern for the electronic device 110 such that the electronic device 110 treats the user of the contact device 160 as a first player or a second player.

The application provider 180 may provide applications to one or more electronic devices. The application provider 180 includes a processor 182, user authenticator 184, and application data 186. The application provider 180 receives request from the electronic device 110 requesting an application that is compatible with the contact device that is in contact with the touchscreen interface of the electronic device 110. The application provider 180 may be prompted for a request for an application. The application provider 180 may request the authentication credentials of the user. The user authenticator 184 may authenticate the credentials provided by the user. After verifying the authentication credentials of the user, the application data 186 may be accessed by the processor 182 and the requested application is transmitted via the network 130 to the electronic device 110.

In some embodiments, the application provider 180 may be provided by the same entity that manufactured the electronic device 110. In some embodiments, the application provider 180 may be provided by the same entity that manufactured the contact device 150. In another embodiment, a 3rd party application provider may provide the application provider 180. The application provider 180 may be accessed by an application that is downloaded on the electronic device 110 (e.g. Apple® app Store®, Android® Marketplace®, Windows® store).

Other application providers may be used to acquire applications that are compatible with the contact devices 150 or 160. Application provider 190 may be a cloud or Internet based application provider that is accessible over the network 130. A web browser on the electronic device 110 may be configured to access the application provider 190. The application provider 190 includes a processor 192, cloud application provider 194, and application data 196.

FIG. 2A shows a flow chart of a process 200 that may be implemented by the data processing system 100 of FIG. 1 to download and execute an application that is compatible with a contact device. With reference to FIGS. 1 and 2A, at block 201, the electronic device 110 activates an application that is configured to receive an identification input from the contact device 150. At block 201, the display device 111 may create a boundary for the placement of the contact device 150. In other embodiments, the identification input from the contact device 150 may be received at any location on the display device 111. In other embodiments, the application for identifying the contact device 150 may be executing in the background of the electronic device 110 such that each time a user places the contact device 150 on the display device 111 the identification input is accepted and another application may be launched.

Next, at block 202, the electronic device 110 receives an identification input from the contact device 150 at a designated portion of the display device 111. The contact device 150 may place one or more contact members on the display device 111. At block 203, the touchscreen interface of the display device 111 may sense the contact members of the contact device 150. Next, at block 204, the contact device identifier circuit 117 may attempt to determine the identification of the contact device 150. If the contact device 150 is unrecognizable, the display device 111 may request that the user rotate the contact device by 90 or 180 degrees, at step 205. After step 205, the process may return to step 203. After step 203, the contact device identifier circuit 117 may attempt to determine the identity of the contact device 150 at step 204. In the case where step 204 is successful, the process moves on to step 206. Next at step 206, the electronic device 110 may access the storage system 120 to determine which application or plurality of applications are compatible with the contact device 150. After determining the identity of the application or applications that are compatible with the contact device 150, at step 207, the storage system 120 may be searched by the application searcher 119 for any of the identified compatible applications for the contact device 150. In various embodiments, a contact device 150 can be predesigned to generate a touch pattern that is compatible with multiple applications. In such embodiments, a user may be offered a choice to select from one of the multiple compatible applications. Upon receiving the selection by the user, the chosen application may be launched. In other embodiments, multiple contact devices may share one touch pattern. In the shared pattern embodiment, user input or selection may be used to identify the application that should be executed. To aid the user in the selection, a list of choices may be presented that include an image of one or more contact devices.

After searching for the compatible application on the storage system 120, at decision block 208, the processor 113 determines whether the application is on the electronic device 110. If the compatible application is on the electronic device 110, the application is offered to the user to be executed, at step 209. In various embodiments, a compatible application can be launched with a parameter, such that the application begins with an understanding that the contact device is present. In various embodiments, the context can be communicated to the compatible application by the application that identified the contact device using, for example, URL schemes. In some embodiments, URL schemes may identify the type of contact device for the application such that the application initiates at an appropriate screen display. If it is determined in step 208 that the compatible application is not on the electronic device 110, the process moves to step 210 where the electronic device 110 queries a compatibility table to determine which application is compatible with the contact device 150. The compatibility table also provides a location for acquiring the application. At step 210, the processor 113 generates a request for the user to activate the application store or a webpage to acquire the compatible application. After receiving the selection by the user, the compatible application may be accessed or downloaded to the electronic device 110 and executed, at step 211.

The parameter or context information that may be communicated to the application may include providing the type of contact device that will operate or provide touch input to the application. In some embodiments, the application may have one, two, three or more modes of operation that are determined by the type of contact device that is going to be providing touch input to the electronic device 110. In other embodiments, there may be portions of an application that are accessible or inaccessible to the user, based on the type of contact device or the context that is provided to the application or received by the application. For example, launching the contact device compatible application after a portal shown in FIGS. 4A-4E has scanned and determined that the contact device is present, may launch the compatible application in a mode that is configured to receive touch input from the contact device without requesting to determine the validity of the contact device. In order to enable or disable such functionality the application may receive context information (i.e., contact device is present) in the form a parameter. In another embodiment, when a compatible application is initiated by the user without the contact device, the compatible application may be configured to receive touch input from one, two, or three fingers of the user. In the multiple finger mode, the compatible application may determine the distance between the fingers and may pause the game when the distance greater than or less than a predetermined distance. Accordingly, in some embodiments, the context information may be the type of contact device that will be operating the application and/or the presence/identification of the contact device.

FIG. 2B illustrates a flow chart of a process 215 that is implemented by the data processing system 100 of FIG. 1 to download an application that is compatible with a contact device. With reference to FIGS. 1 and 2B, at step 220, the electronic device 110 receives an identification input through a touch sensitive display device, such as a touch screen. A contact device may create the identification input from the contact members that are touching the display device 111. The identification input may be a pattern generated by the contact members that may be used to identify the one or more compatible applications. Next at decision block 222, a search is conducted to determine whether one or more applications associated with the identification input are located on the electronic device 110. The application searcher 119 may perform the search for the application that is associated with the contact device. When the answer at decision block 222 is no, the process 215 goes to step 224 where the user is directed to an application download message for downloading one or more applications. When the answer at decision block 222 is yes, the process moves to decision block 226. At decision block 226, the processor determines whether one or more applications that is compatible with the contact device resides on the electronic device 110. When the result of decision block 226 is no, the process goes to step 228. In some embodiments, at decision block 226, the processor may determine that one or more applications are compatible with the contact pattern created by the contact device because one contact device is compatible with multiple applications or because multiple contact devices share the contact pattern. When more than one application may be compatible with a contact device, the user may be prompted to select an application to execute. At step 228, the electronic device 110 downloads the compatible application and executes the compatible application. When the answer to decision block 226 is yes, the user is directed to the application when the one or more applications are available on the electronic device 110, at step 230.

FIG. 2C is another process 240 implemented by the data processing system 100 of FIG. 1 to download an application that is compatible with a contact device. With reference to FIGS. 1 and 2C, at step 250, the electronic device 110 receives an identification input through a touchscreen interface. Next at step 252, the application searcher 119 determines whether one or more applications that are associated with the identification input is on the electronic device 110. At step 254, the display device 111 may generate a display of the electronic device 110 showing representations of the one or more applications associated with the identification input. Next at step 256, the application searcher 119 determines whether one or more applications reside on the electronic device 110. At step 258, the application data 122 may use the compatibility table shown in FIG. 3 to determine whether each of the one or more applications is compatible with that contact device. Next at step 260, the process may direct the user to the application when one of the one or more applications reside on the electronic device 110 and is compatible with the device associated with the contact device identification input. Alternatively, at step 262, the process may direct the user to an application download page either when the one or more applications do not reside on the electronic device 110 or when the one or more applications does reside on the electronic device 110 but the one or more applications are not compatible with the contact device that is associated with the identification input.

FIG. 3 is an example device compatibility table 300 that is used for determining the identity of a compatible application. With reference to FIGS. 1 and 3, the device compatibility table 300 may be accessed by the electronic device 110 to determine the name of the compatible application, and the location of the compatible application. After determining the location of the compatible application, the electronic device 110 may request user input to download the compatible application when the compatible application is unavailable on the electronic device 110. The device compatibility table may include a contact device column 301, an application name column 303, and a location column 305. The contact device column 301 may list a first device 307, a second device 309, and an option to add a new device 341. In the application name column 303, adjacent to the new device 341 row, there is an option to add an application in box 343. Similarly, adjacent to the add application box 343, there is an option to add location 345 in the location column 305.

In the row for first device 307 three application versions are listed. The first device 307 is compatible with application version #1 309, application version #2 315, and application version #3 321. In the location column 305 for the first device 307 there are two locations that are listed, a web address 311 (e.g., http://www.firstdeviceappv1.html) and an application store link 313. The electronic device 110 may access the compatible application using the web address 315 or download the application version #1 309 using the application store link 313. The first device 307 is also compatible with application version #2 315 and the compatibility table 300 lists web address 317 and third party website 319 as locations for accessing or downloading application version #2 315. As shown in FIG. 3, first device 307 is also compatible with application version #3 321, which may be downloaded at application store link 323.

The second device 325 is compatible with second device application version #1 327 that may be located at application store link 329 and/or web address 333. The second device 309 is also compatible with an application version #2 335 that may be located at application store link 337 and web address 339. In other embodiments, an application that is compatible with the contact device may already be stored on the electronic device 110. The device compatibility table 300 may include a link to the application residing on the electronic device 110 that is compatible with the contact device. In other embodiments, the electronic device 110 may execute the compatible application after using the device compatibility table 300. In other embodiments, when an older version of an application that is not compatible with a new contact device is present on the electronic device 110, the processor 113 of the electronic device 110 may either contact a web server to determine that the compatibility table 300 needs to be updated or present the user with an option to update the application. Accordingly, the compatibility table 300 may be updated, using a remote database, and the electronic device may also download an application that is compatible with the new contact device.

In some embodiments, when a new device 341 is in contact with the display device 111, the compatibility table 300 may be appended to in order to add the new device. The electronic device 110 requests the application name and location of the new application from the user for the new device, in some embodiments. In other embodiments, when a new device 341 that is not in the device compatibility table 300 is scanned by the scanning application of the display device 111, the scanning application may be upgraded and thus the application store may be prompted to upgrade the scanning application. Accordingly, an upgrade to the scanning application may include updating the device compatible table 300.

FIG. 4A is a screen shot of an electronic device for identifying a contact device. FIG. 4A illustrates an electronic device 400 that includes an input button 402 and a display screen 404. The electronic device 400 may include each of the components described above with respect to electronic device 110 (refer to FIG. 1). The display screen 404 may be a touch sensitive screen. In the example shown in FIG. 4A, the display screen 404 shows a portal area 406 that includes a button 408. FIG. 4A illustrates an image 410 that represents a different contact device, in some embodiments. In one embodiment, the portal area 406 is the only area on the display screen 404 that is touch sensitive when the portal 406 is activated on the display screen 404. By selecting the button 408 a user may move the portal 406 downward on the screen and only a portion of the portal may be displayed, deactivating the portal 406. When the portal 406 is activated using the button 408, the touch sensitivity of the display screen is limited to the area occupied by the portal 406, in one embodiment. In another embodiment, the entire area occupied by the display screen 404 may be sensitive to touch by a user or one or more contact members.

FIG. 4B is an illustration of a contact device 412 being placed on the electronic device 400 from FIG. 4A. As shown in FIG. 4B, the contact device 412 includes four contact members 414, 416, 418 and 420 that are laid out in an input pattern. A contact device 412 may be in physical contact with the display device 404, in some embodiments. The display device 404 may include a touch screen interface capable of sensing a pattern generated by the contact members 414, 416, 418 and 420 of the contact device 412, in various embodiments. The touch screen interface of the display device 404 may recognize the contact pattern and send the recognized contact pattern to the contact device identifier circuit, in some embodiments. The contact device identifier circuit may receive the contact pattern that is generated on the display device 404 when the contact members 414, 416, 418 and 420 touch the display device 404 within portal 406. In other embodiments, when the user places the contact device 412 with a different orientation, the portal 406 may inform the user to rotate the contact device 412.

FIG. 4C is an illustration of a screen from an application that is compatible with the contact device 412 from FIG. 4B. The contact device 412 may be identified based on the distance between the contact members that are represented by the length of the lines that are connecting the contact members, as shown. The lines that are connecting the contact members are shown for illustration purposes and the display screen 404 does not illustrate the lines. The contact device 412 is shown in dashed lines to illustrate that the contact members are located at the bottom surface of the contact device 412. After the contact device 412 has been recognized by the electronic device 400 and an application searcher has located the compatible application on the electronic device 400, the display screen 404 may generate a menu 422 for the user.

The menu 422 prompts the user to play the application by selecting a play application button 424. The menu 422 shows a logo 426 for the application or an image of the contact device 412. When the user selects the play application button 424, the display screen 404 generates a display that is responsive to the user moving the contact device 412 across the surface of the display screen 404. The contact members of the contact device 412 provide input to the compatible application and, in some embodiments, besides the location of the contact members there is no other information that is transmitted from the contact device 412 to the electronic device 400.

FIG. 4D is an illustration of a screen for downloading a compatible application when the compatible application is not located on the electronic device 400. In FIG. 4D, the electronic device 400 does not have the compatible application located on the electronic device 400. For example, the application searcher performed a search in the storage system and the application data determined that the one or more applications that are compatible with contact device 412 was unavailable on electronic device 400. As a result, menu 430 is displayed for the user. Menu 430 includes an open application store button 432 and an open website button 434. The user may select one or the other options from menu 430. When the user wishes to download the application, the user may choose the open applications store button 432. When the user wishes to access the compatible application, the user may choose the open website button 434. In some embodiments, the open applications store button 432 may be the only button that is displayed. In other embodiments, the open website button 434 may be the only button that is displayed.

FIG. 4E is a screen shot of an application store screen that allows a user to download the compatible application. The application store screen 436 includes an image 438, price 440, application name 442, and logo 444. In one embodiment, FIG. 4E may be displayed on the display screen 404 after FIG. 4B. In another embodiment, the compatible application may be automatically downloaded from the screen displayed in FIG. 4D without showing the application store screen 436. The image 438 may be an image that illustrates the device 412 being used by a user with an image that may be displayed by the application. The logo 444 may also include an image that includes showing a portion of the contact device 412, which allows the user to visually verify that the application is compatible with the contact device 412. The electronic device 400 may receive input from the user to purchase the application when the user selects the price button 440. The electronic device 400 may prompt the user for payment credentials or authentication credentials for the application store that is being accessed. After downloading the application onto the electronic device 400, the application that was downloaded may be initiated and contact device 412 may provide input data via the contact members to the electronic device 400. In response to the movements of the contact members of the contact device 412, the display screen 404 may change the display.

The embodiments of the data processing systems or methods are described with reference to drawings. The drawings illustrate certain details of specific embodiments that implement the systems and methods and programs that are described. However, describing the embodiments with drawings should not be construed as imposing on the embodiments any limitations that may be present in the drawings. The embodiments contemplate methods, systems, and program products on any machine-readable storage media for accomplishing its operations. The embodiments may be implemented using an existing computer processor, or by a special purpose computer processor incorporated for this or another purpose or by a hardwired system.

As noted above, embodiments include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machine to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions include a general purpose computing computer in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the embodiments as defined in the appended claims. Such variations will depend on the software and hardware systems chosen and on designer choice. It is understood that all such variations are within the scope of the embodiments. Likewise, software and web implementations of the present invention could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the scope of the embodiments to the precise form disclosed, and modifications and variations are possible in light of the above teachings. The embodiments were chosen and described in order to explain the principles and its practical application to enable one skilled in the art to utilize the embodiments in various embodiments and with various modifications as are suited to the particular use contemplated. Other substitutions, modifications, changes and omissions may be made in the design, operating conditions and arrangement of the embodiments without departing from the scope of the present invention as expressed in the appended claims.

What is claimed is:

1. An electronic device, comprising:
a touch sensitive display screen capable of receiving contact information from a contact device;
a processor configured to identify the contact device based on an identifying pattern the contact device creates when the contact device is in contact with the touch sensitive display screen;
the processor configured to determine whether one or more applications that are compatible with the contact device is absent from the electronic device; and
the processor configured to generate a message to download or access the one or more applications that are compatible with the contact device.

2. The electronic device of claim 1, wherein the processor is configured to search a memory of the electronic device for the one or more applications that are compatible with the contact device prior to generating the message.

3. The electronic device of claim 1, wherein the processor is configured to generate choices to either download the one or more applications at an application store or access a URL to access the one or more applications on the electronic device.

4. The electronic device of claim 1, wherein the processor is configured to direct a user to an application download webpage when the one or more applications is absent from the electronic device.

5. The electronic device of claim 1, wherein the processor is configured to conduct a search based on a contact device compatibility table that includes one or more application versions and a resource locator for the one or more applications that are compatible with the contact device.

6. The electronic device of claim 1, wherein a manipulation of the contact device relative to the display device changes an output generated by the touch sensitive display device when the one or more applications is being executed by the electronic device.

7. A system comprising;
an electronic device that comprises a processor and a touch sensitive display screen that is configured to receive identification input from a contact device;
wherein the processor is configured to display a message to download one or more applications that are compatible with the contact device after the processor determines that the one or more applications are absent from the electronic device; and
wherein the processor is configured to change a display output based on interactions with the contact device when the one or more applications that are compatible with the contact device are present in the electronic device.

8. The system of claim 7, wherein the electronic device is configured to determine that the one or more applications that are compatible with the contact device are absent from the electronic device or one or more incompatible applications is on the electronic device and should be upgraded to utilize the features of the contact device.

9. The system of claim 8, wherein the electronic device is configured to automatically download the one or more applications after determining that the one or more applications are absent from the electronic device; and
wherein the contact device is an inanimate object.

10. The system of claim 7, wherein the processor is configured to generate the message that directs a user to download the one or more applications or directs the user to a URL in a web browser that allows a user to install the one or more applications on the electronic device.

11. The system of claim 8, wherein the electronic device is configured to receive an indication from the contact device via a user selectable option button to indicate to the electronic device via the touch sensitive display screen to automatically download the one or more applications that are compatible with the contact device.

12. The system of claim 11, wherein after downloading a compatible application, the processor is configured to change a display to indicate that the location of the contact device is changing in relation to the touch sensitive display screen when the one or more applications that are compatible with the contact device is being executed by the electronic device.

13. A method comprising:
receiving an identification input through a touch sensitive display device on an electronic device;
determining one or more applications associated with the identification input;
directing a user to an application when one of the one or more applications is available on the electronic device and is compatible with the contact device associated with the identification input; and
directing the user to an application download message for downloading the one or more applications when the one or more applications is absent from the electronic device or when the one or more applications that is on the electronic device is incompatible with a contact device associated with the identification input.

14. The method of claim 13, wherein receiving an identification input includes the contact device having one or more contact members that are detected by the touch sensitive display device; and
wherein the contact device is identified based on a pattern that is created by the contact members that are detected.

15. The method of claim 13, further comprising determining whether the one or more applications is present on the electronic device.

16. The method of claim 13, further comprising determining whether each of the one or more applications is compatible with the contact device associated with the identification input.

17. The method of claim 13, further comprising accessing a storage database using the identification input received from the contact device to determine the one or more applications that is compatible with the contact device.

18. The method of claim 13, further comprising displaying on the touch sensitive display device the download message upon determining that the one or more applications is unavailable on the touch sensitive display device.

19. The method of claim 18, wherein the touch sensitive display device indicates to the user via the display device an identification input area in which the contact device should be placed in order to receive the identification input from the contact device.

20. The method of claim 18, wherein the touch sensitive display device disables touch sensitivity in the area that is located outside the identification input area on the touch sensitive display device.
